(19) United States
(12) Patent Application Publication
(10) Pub. No.: US 2010/0157345 A1
(43) Pub. Date: Jun. 24, 2010

(54) SYSTEM FOR AUTHORING EDUCATIONAL ASSESSMENTS

(75) Inventors: Robert M. Lofthus, Webster, NY (US); Kristine A. German, Webster, NY (US); Dennis C. DeYoung, Webster, NY (US); Dennis L. Venable, Marion, NY (US); Michael R. Campanelli, Webster, NY (US); Steven J. Harrington, Webster, NY (US); Charles A. Baxter, Rochester, NY (US); Gavan L. Tredoux, Penfield, NY (US); Peter J. Zehler, Penfield, NY (US); Rajinderjeet S. Minhas, Churchville, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/341,659

(22) Filed: Dec. 22, 2008

(51) Int. Cl. G06F 3/12

(52) U.S. Cl. 358/1.13

(57) ABSTRACT

An assessment authoring system implemented by an operative set of processor executable instructions configured for execution by at least one processor includes a user interface and an assessment generation component. The user interface communicates user input and the assessment generation component receives the user input from the user interface. The assessment generation component generates an assessment data structure for printing on a multifunction device. The printed assessment includes a marking region adapted to receive a human marking. The system may utilize a model or rubric that can be used to score the human marks when are processed by image processing.

### BACKGROUND

1. Technical Field

The present disclosure relates to multifunction devices, and in particular, to a system for authoring educational assessments for printing on multifunction devices.

2. Description of Related Art

In recent years the basic office copier has evolved into what can be called a “multi-function device” or MFD. With digital technology, a machine with the basic outward appearance of a traditional copier can perform additional functions such as printing documents submitted in digital form over a network; sending and receiving messages via facsimile; recording hard-copy original images in digital form and sending the resulting data over a network, such as in electronic mail; or recording hard-copy original images in digital form on a compact disc or equivalent medium. These additional functions present further challenges to a designer of a convenient and intuitive user interface.

The present disclosure is directed utilizing MFDs to creating, grading, and analyzing the results of tests administered to students, and in particular, to a computer-implemented educational assessment system and method for generating and administering student assessments, evaluating the results thereof to enable educators to identify strengths and weaknesses of students both individually and in the aggregate, and tailoring the learning experience of students in a classroom environment.

Classroom education historically has had a one-to-many structure wherein a lesson is presented by a teacher presents to a group of students. For example, a typical mid-19^{th} century classroom might include group of students representing a broad range of age and intelligence. Most likely, one would find that all the children and teenagers in the community grouped together in a single classroom under the auspices of a single teacher. Accordingly, lesson plans were often broadly focused in order to accommodate the disparate needs of such a varied student populace, which as a result left the educational needs of some students unfulfilled, while leaving other students overwhelmed.

The present disclosure relates to the process of assessing the attributes of a student or group of students at selected times during their learning process and particularly relates to the assessment and evaluation of student attributes or progress in a structured classroom where a teacher is required to educate the students to a level of proficiency in various subject matters and at particular grade levels. Typically, in a grade level classroom, the teacher periodically gives the students printed form assessments or tests, as they have previously been referred to, in order to obtain an indication of the student(s) level(s) of proficiency in the subject matter of immediate interest.

Where a teacher is responsible for a class having a relatively large number of students, the teacher typically passes out to all students a common assessment form. The assessments are distributed to the students who then mark their responses on the forms which are then gathered by the teacher and individually reviewed and evaluated or graded by the teacher. The process has required the teacher to then manually enter an overall metric of each student's performance on the assessment into a record book or database. Typically the metric is a single total score or percentage of possible points. This process has thus been time consuming and often requires the teacher to spend considerable time outside of the classroom performing these functions. Furthermore, no detailed record is kept regarding how each student performed on each item within the assessment. Given the low resolution metric recorded for each assessment, the recorded results do not fully or meaningfully determine the state of learning of individual students who may be experiencing learning difficulties or are insufficiently prepared for particular elements of the assessment. For example, all students whose total score is 601100 on an assessment are most likely not making the same incorrect or correct answers, but it is not possible to differentiate their performance if only total scores are recorded.

Thus, it has been desired to provide a way or means of automatically scoring and recording detailed assessment results for students in a relatively large class, thereby eliminating the need for manually scoring and entering the results of the evaluations in a record book or database, and eliminating the loss of critical data inherent in the practice of recording only total scores or percentages.

### SUMMARY

The present disclosure relates to multifunction devices, and in particular, to a system for authoring educational assessments for printing on multifunction devices.

In one embodiment of the present disclosure, an assessment authoring system is implemented by an operative set of processor executable instructions configured for execution by at least one processor and includes a user interface and an assessment generation component. The system can further include a marketplace interface component adapted to communicate the assessment data structure with an electronic marketplace. The user interface communicates user input and the assessment generation component receives the user input from the user interface. The assessment generation component generates an assessment data structure for printing on a multifunction device. The printed assessment includes a marking region adapted to receive a human marking. The printed assessment may be adapted for image processing.

The assessment data structure can further include a meta-datum adapted to associate the human marking within the marking region with a printed question. Additionally or alternatively, a meta-datum is included within assessment data structure and is adapted to indicate a collection type; the collection type being adapted to indicate an expected human marking of the human marking. The collection type is one of a multiple-choice collection type, a multiple-choice-sequential collection type, a fill-in-the-box collection type, a singles collection type, and/or a multiple-choice-survey collection type.

In other embodiment of the present disclosure, the user input may be adapted to instruct the assessment authoring tool to generate question data such that the question data is adapted to instruct a multifunction device to print the question on the printed assessment. The user input may also be adapted to instruct the assessment authoring tool to generate a meta-datum indicating an answer corresponding to the human marking occurring in the marking region and/or the meta-datum can be further adapted to indicate a mark type, e.g., Indicates Error, Indicates Correct, Selects Result, Is Result, Survey Selection, and Connector.

In another embodiment of the present disclosure, the user interface is adapted for user preview of the printed assessment including user preview of the marking regions. The marking region is selected via received user input from the user interface.

In yet another embodiment of the present disclosure, a system for printing assessments on a multifunction device includes a user interface and an assessment generation component. The user interface is adapted to communicate user input. The assessment generation component is in operative communication with the user interface and is configured to receive the user input therefrom. The assessment generation component is adapted to generate an assessment data structure as at least a function of the user input. The assessment data structure includes printing data and meta-data. The printing data operatively instructs the multifunction device to print an assessment having at least one marking region adapted to receive at least one human marking. The printing data can include one or more of a page description language data structure, a portable document format data structure, a postscript data structure, a raw image, a compressed image, and/or a print job.

The meta-data includes a meta-datum adapted to indicate an answer corresponding to a human marking of the at least one human marking occurring in a marking region of the at least one marking region. The meta-datum can indicate the answer is one of a correct answer and an incorrect answer as corresponding to the human marking of the at least one human marking occurring in the marking region of the at least one marking region. Additionally or alternatively, the assessment generation component may also generate the assessment data structure by modifying another assessment data structure (e.g., a stored assessment data structure). The assessment generation component can generate the assessment data structure such that the printing data includes a scanned image. Additionally or alternatively, the assessment generation component operatively utilizes an assessment data structure template to generate the assessment data structure.

The meta-data can include at least one global meta-datum. The at least one global meta-datum includes at least one of a bar code field, a bar code print location, a variable print data pointer, a variable print data print location, a document name, a print characteristic, a registration mark and/or a registration mark print location. The at least one global meta-datum is adapted to instruct the multifunction device to print a print object within a print region of the printed assessment.

In yet another embodiment of the present disclosure, the user interface is further adapted for user preview of the printed assessment including user preview of the at least one marking region. The user interface is further adapted for user selection of a second marking region of the at least one marking region utilizing the user preview of the at least one marking region and the system further comprises a meta-datum configuration component in operative communication with the user interface and adapted to receive user input therefrom. The meta-datum configuration component is adapted to configure a second meta-datum of the meta-data of the assessment data structure such that the second meta-datum is adapted for association with a second human marking of the at least one human markings within the selected second marking region of the at least one marking region.

In yet another embodiment of the present disclosure, the printing data of the assessment data structure includes a question datum adapted to operatively instruct the multifunction device to print a question on the printed assessment. The question is associated with the human marking of the at least one human marking within the marking region of the at least one marking region. The meta-datum is adapted to indicate the answer as corresponding to the human marking such that the human marking is in response to the printed question.

### BRIEF DESCRIPTION OF THE DRAWINGS

These and other advantages will become more apparent from the following detailed description of the various embodiments of the present disclosure with reference to the drawings wherein:

FIG. 1 shows an illustration of an educational assessment system in accordance with the present disclosure;

FIG. 2 shows an illustration of an education assessment system utilizing an authoring system for authoring educational assessments in accordance with the present disclosure;

FIG. 3 shows a block diagram of a system for authoring education assessments as utilized by the education assessment system of FIG. 2 in accordance with the present disclosure; and

FIG. 4 shows a graphic of a user interface usable with the system of FIG. 3 in accordance with the present disclosure.

### DETAILED DESCRIPTION

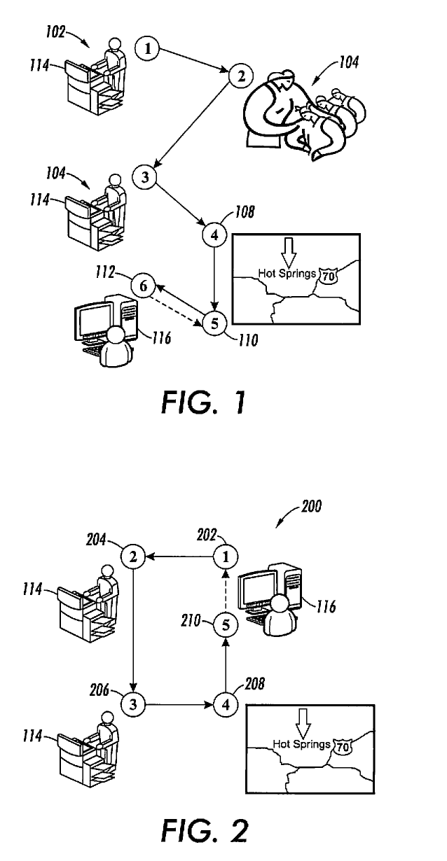

Referring to the drawings, FIG. 1 shows an illustration of an educational assessment system 100 in accordance with the present disclosure. System 100 includes stages 102 through 112. A teacher and/or school administrator may utilize system 100. A teacher identifies herself to the MFD 114 during stage 102 by logging into system 100. The teacher can log into system 100 utilizing any authentication and/or security technology. For example, the teacher (or authorized user) can log into system 100 using a unique ID, a username, an RFID tag, a smart card, a passphrase, and the like. Additionally or alternatively, the teacher logs into MDF 114 using a touch-screen display. Several assessments are presented to the teacher so that she can choose among them to print. The chosen assessments are then printed during stage 102. At stage 104, the teacher administers the assessments to one or more students. During stage 106, the teacher scans in the assessments into MDF 114. MDF 114 can convert the scanned assessment into a Page Description Language File, image data, and/or other format. MDF 114 and/or a server (not shown) may perform processing on the scanned assessments. During stage 108, the assessments are evaluated, e.g., an algorithm (not depicted) grades the assessments using a rubric (not depicted). Stage 108 evaluates the assessment by reviewing the human markings. The teacher may be notified by the algorithm that the assessments have been evaluated, e.g., via email, text message, a printed page and the like. During stage 110, the teacher can verify and/or correct how the assessments were graded using personal computer 116. During stage 112, the teacher requests reports about the assessment to design other assessments and/or to tailor the teaching of the students. Stages 110 and/or 112 may be repeated several times. In other embodiments, stages 102 through 110 may vary in sequence, some stages may be performed in a serial manner or a parallel manner, and/or some stages may be performed in a step-wise manner.

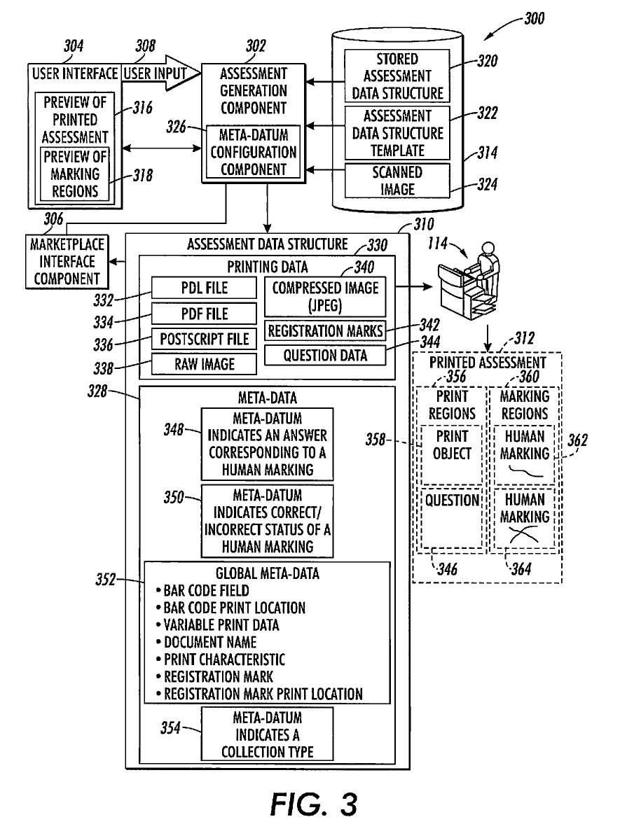

Referring to the drawings, FIG. 2 shows an illustration of an education assessment system 200 utilizing an authoring assessment authoring system 300 (discussed below) for authoring educational assessments. System 200 includes stages 202 through 210. During stage 202, a teacher uses an authoring assessment authoring system 300 (see FIG. 3 and the discussion below) to create a ‘trial’ assessment and associated rubric, which is attached as meta-data for scoring and/or evaluation purposes. The teacher associates the use of this ‘trial’ assessment with a small (as small as one student) pseudo-class of students and also validates that pseudo-class as one of her classes, which will appear as a valid class when the teacher access the data via MFD 114 and/or personal computer 116.

During stage 204, the teacher identifies herself on MFD 114, e.g., by pressing a “MY MFD” button on the touch screen. The teacher may opt to print a trial assessment for a pseudo-class. The trial assessment may be utilized to determine if the assessment is sufficient and/or if modification needs to be made. The teacher thereafter verifies the appearance of the assessment, and if satisfied, can add ‘purposeful’ marks to the assessment to simulate assessing the pseudo-class. If the teacher is not satisfied with the printed assessment then the teacher may make modifications using MFD 114 and/or personal computer 116; thereafter the teacher may return to stage 202 again. During Stage 206, the teacher scans in the marked assessments, e.g., by pressing the “MY MFD” button again on the touch screen display. During stage 208, the assessment are evaluated and the teacher may be notified, e.g., by email, or other communications technology. As previously mentioned, MDF 114 can convert the scanned assessment into a Page Description Language File, image data, and/or other format. MDF 114 and/or a server (not shown) may perform processing on the scanned assessments.

During stage 210, the teacher can validate the scoring and/or the report generation. The report and scoring should correlate to the purposeful markings the teacher made. Modifications may be made during stage 210 and the teacher may return to one of the previous stages 202 through 208. During stage 210, she may interface into a server via personal computer 116 (or MFD 114 itself) and store the assessments as part of a database.

Additionally or alternatively, the assessment may be uploaded into a digital marketplace, such as an e-commerce website in which the teacher (or her institution) may be compensated based upon other teacher's utilization of the assessment. Assessment data structure 310 may be shared with other teacher locally.

Additionally or alternatively, assessment data structure 310 may be shared via a web service with other teachers, school, and/or school districts. The money collected may be paid to the teacher, her school, and/or her school district. Assessment data structure 310 may be sold per printed assessment, via a one-time license, and/or may have an extra charge for making changes and re-selling the assessment data structure 310. Statistics may be kept regarding the marketplace of the marketplace provider.

Referring to the drawings, FIG. 3 shows a block diagram of an assessment authoring system 300 for authoring education assessment as utilized by the education assessment system 200 of FIG. 2 in accordance with the present disclosure. Assessment authoring system 300 includes an assessment generation component 302, a user interface 304, and a marketplace interface component 306. MFD 114 may be considered part of or separate from assessment authoring system 300. Additionally or alternatively, assessment authoring system 300 may be implemented utilizing the hardware and/or software of MFD 114.

Assessment authoring system 300 may be implemented in hardware, software, software in execution, firmware, microcode, bytecode, in virtualization, in simulation, on a personal computer, and the like. For example, assessment authoring system 300 may be implemented in VHDL and/or by utilizing FPGA. Additionally or alternatively, assessment authoring system 300 may be an installable module installable in a xerographic apparatus.

User interface 304 is in operative communication with assessment generation component 302, and assessment generation component 302 is in operative communication with marketplace interface component 306. The communications may be packet-based, virtual circuit based, and/or may utilize hardware or software. Additionally or alternatively, the communications may be through any sufficient physical or informational medium such as light, sound, ultrasonic vibrations, electric fields, electricity, data communications, TCP/IP, and the like.

Assessment authoring system 300 receives user input 308 via user interface 304. User interface 304 operatively communicates user input 308 with assessment generation component 302. Assessment generation component 302 utilizes user input 308 and/or store 314 to generate assessment data structure 310. Assessment data structure 310 is adapted for printing on MFD 114 such that printed assessment 312 is printed.

User interface component 304 may be a graphical user interface, e.g., a “window” box in a LCD display as shown by a GUI based operating system. User interface 304 is adapted to show a preview of printed assessment 314 including a preview of marking regions 316. Preview of printed assessment 312 may be approximated and/or estimated representation of a printed assessment. An assessment need not be printed for viewing of the preview of printed assessment 314.

Assessment generation component 302 is in operative communications with store 314. Store 314 includes stored assessment data structure 320, assessment data structure template 322, and scanned image 324. Store 314 may be a database (e.g., a SQL based database), and/or may be implemented in volatile or non-volatile memory, a magnetic storage medium, an optical storage medium, a cache, a heap, and the like. Stored assessment data structure 320 may be another assessment similar or identical to assessment data structure 310. For example, stored assessment data structure 320 may be a digitally-compressed stored version of assessment data structure 310. Assessment data structure template 322 may be a pre-made form to assist the user in authoring assessment data structure 310. Scanned image 324 may be a scanned image scanned into system 300 via MFD 114.

Assessment generation component 302 includes meta-datum configuration component 326. Meta-datum configuration component 326 allows a user to configure and/or generate some of (or all of) meta-data 328 of assessment data structure 310. As previously mentioned, assessment generation component 302 generates assessment data structure 301. Assessment data structure 310 includes printing data 330 and meta-data 328. Printing data 330 may include one or more of PDL file 332, PDF file 334, raw image 338, compressed image 340, registration marks 342, and question data 334. Printing data 330 instructs MFD 114 to print printed assessment 312. Question data 344 may be an image of a question and/or may include printing instructions to instruct MFD 114 to print questions 346.

Although the assessment data structure 310 is shown as having printing data 330 and meta-data 328, it is contemplated in other embodiments that printing data and/or meta-data are separate; for example, meta-data 328 may include a pointer (not shown) such as a filename to indicate that the meta-data 328 is associated with the printing data 330.

Assessment data structure includes meta-data 328 including meta-datum 330, meta-datum 348, meta-datum 350, global meta-data 352, and meta-datum 354. As previously mentioned, assessment data structure 310 is printed by MFD 114 as printed assessment 312. Printing data 330 instructs MFD 114 to print printed assessment 312 including print regions 356 having print object 358 and question 346. Additionally, printed assessment 312 includes marking regions 360 such that a human can (after being printed) make marking 362 and human marking 364.

Printing data 330 instructs MFD 114 to print printed assessment 312. Printed assessment 312 includes print regions 356 where inks or toners may be marked on paper (e.g., text, objects, monotone objects, B&W halftone object, color objects and the like). For example printed assessment 312 may be several pages of A4 paper and print object 358 may be a school logo in the corner of a printed page. Question 346 is a student question marked on paper. Marking regions 360 are spaces or regions on printed assessment 312 in which a student (or teacher for diagnostic purposes) can make markings such as a human markings 362 and 364. For example, question 346 may include the text “Place an X on the Dog” accompanied with several drawings of animals. The student can mark an “X” on one of the shown animals (not depicted) resulting in human marking 364. Thereafter printed assessment 312 is scanned by MFD 114 for image processing.

As mentioned supra, assessment data structure 310 includes meta-data 328 having meta-data 348, 350 and 354, and global meta-data 352. Meta-data 328 may be created before the printing of printed assessment, during the printing of printed assessment 312 and/or after image processing is performed of printed assessment 312 including image processing of marking regions 360.

Meta-datum 348 includes an answer corresponding to a human marking, e.g., human marking 364 may indicate that an “X” was drawn. Meta-datum indicates correct/incorrect status of a human marking, e.g., human marking 364 may have an “X” over the wrong animal or the correct animal. Meta-data 352 may include a bar code field to instruct MFD 114 to print a bar code, a bar code print location to instruct MFD 114 where to print a bar code, variable print data, a document name, a print characteristic, a registration mark and/or a registration mark print location. Meta-datum 354 includes a collection type such as of a multiple-choice collection type, a multiple-choice-sequential collection type, a fill-in-the-box collection type, a singles collection type, and a multiple-choice-survey collection type. The collections types may correspond to one or both of human markings 362 and/or 364. The collection type may be utilized by MFD 114 in image processing and/or to generate meta-data 348 and/or 350.

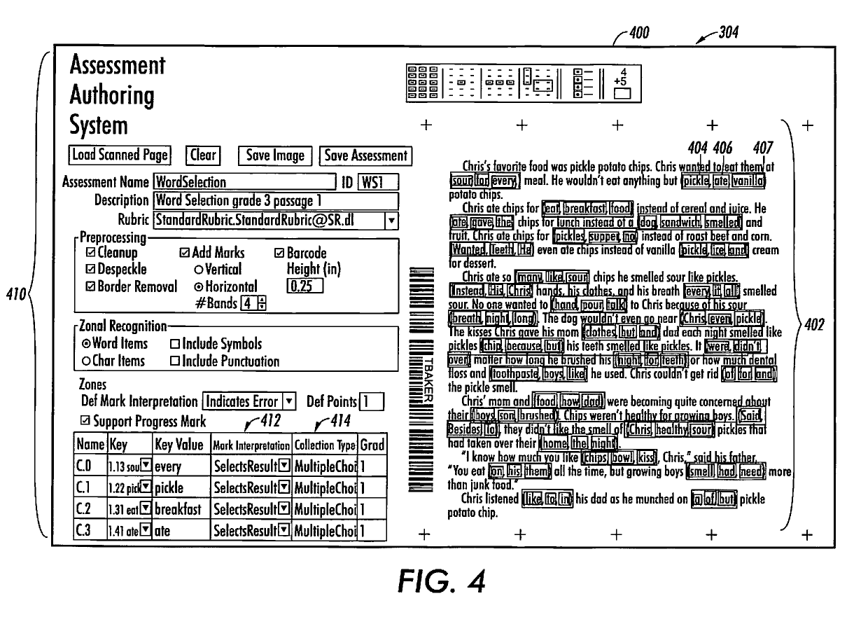

Referring to FIGS. 3 and 4 simultaneously, FIG. 4 shows a graphic of a user interface 304 of system 300 usable with the authoring assessment system 300 in accordance with the present disclosure. User interface 304 is shown as a GUI interface. User interface 304 includes a window 400 having scanned image 402 of text including words 404, 406, and 408. Words 404, 406, and 408 are selectable by User Interface 304. The meta-data configuration component 326 (see FIG. 3) is in operative communications with a user via GUI portion 410. GUI portion 410 includes mark interpretation selector 412 and collection type selector 414 wherein scanned image 402 may be associated with assessment data structure 310 such that words 404, 406, and 410 are marking regions 360 adapted for human markings. The words 404, 406, and 408 may be considered as printed versions of question 346.

Each of words 404, 406, and 406 may be selected as a multiple-choice collection type, a multiple-choice-sequential collection type, a fill-in-the-box collection type, a singles collection type, a multiple-choice-survey collection type, and connector collector type. The multiple-choice collection type is adapted so that a human marking can select a group of objects where one of them is the correct answer. The multiple-choice-sequential collection type is adapted so that a human marking can indicate from among words 404, 406, and 408 a correct word in an in-line arrangement. A fill-in-the-box collection type is adapted so that a human marking can indicate an answer such as the answer to the question: “what is 2+2=?”. The fill-in-the-box collection type may be indicated by a “______” marking region to indicate the marking region to the student.

A singles collection type is adapted so that a human marking can indicate which item on the page is selected, e.g., a teacher may give the student a flash card and the student is asked to repeat the letter, and the teacher may cross out a letter on a grading sheet to indicate a wrong answer. A multiple-choice-survey collection type is adapted so that a human marking can indicate an answer to a survey question not having a “correct”-“incorrect” dichotomy.

A connector collector type is adapted so that a human marking can indicate an answer via drawn lines between matching pairs; for example, a list of the words “dog”, “cat” and “elephant” may be shown near three pictures showing each respective animal. The student can draw a “connector” (the human marking is the connector line) between the word and picture which the student selects as corresponding to the word.

Human markings 362 and 364 may be defined as Indicates-Error indication type, Indicates-Correct indication type, Selects-Result indication type, Is-Result indication type, Survey-Selection indication type, and Connector indication type. Mark types are options that are selected by the user of the system for “teaching” the system how to interpret the marks. Indicates Correct and Indicates Error mark types are utilized by the teacher to instruct the system how to interpret certain marks to indicate if the mark is should be interpreted as a correct or incorrect response, respectively, such as when asking the student to recite a displayed word. The teacher may circle the word to indicate a correct response and “x” a word in indicate an incorrect response. Selects-Result is a mark type that is a result of a human marking that indicates the selected item from a multiple choice question. Each question would have several possible “items” that can be marked by the person taking the test. For example, in the following question the student has to make a mark through the correct word: “Harry got up early and [saw, went, ate] to eat breakfast.” You have three “items” there which can be selected. This is used to teach the system that if the second item is marked (Selects Result) then it's correct. Is Result mark type is used for fill in the bubble type where you are not marking the actual item but instead an item (maybe next to it like a bubble) that indicates which answer you are giving. Survey Selection mark type is like the multiple-choice mark type but where more than one item can be selected and/or there is not necessarily just one answer (or any answers) that is correct. A connector mark type is type of mark drawn between two items. For example, when a student is shown a row of pictures on one side of the page and a row of words on the other side of the page and the student has to dray lines (connectors) connecting the correct word and the picture pair. The connector pairs may correspond to an answer.

What is claimed is:

1. An assessment authoring system implemented by an operative set of processor executable instructions configured for execution by at least one processor, comprising:
a user interface adapted to communicate user input;
an assessment generation component in operative communication with the user interface and adapted to receive the user input therefrom, wherein the assessment generation component is adapted to generate an assessment data structure for printing on a multifunction device, the printed assessment includes a marking region adapted to receive a human marking, wherein the assessment data structure is further adapted to include a meta-datum associated with at least one of a human marking and an anticipated human marking.

2. The system according to claim 1, wherein the assessment data structure further includes the meta-datum adapted to associate the human marking within the marking region with a printed question.

3. The system according to claim 2, wherein the meta-datum is further adapted to indicate a collection type, the collection type being adapted to indicate an expected human marking of the human marking.

4. The system according to claim 3, wherein the collection type is one of a multiple-choice collection type, a multiple-choice-sequential collection type, a fill-in-the-box collection type, a singles collection type, a multiple-choice-survey collection type, and connector collector type.

5. The system according to claim 2, wherein the user input is adapted to instruct the assessment authoring tool to generate question data, wherein the question data is adapted to instruct a multifunction device to print the question on the printed assessment.

6. The system according to claim 1, wherein the user input is adapted to instruct the assessment authoring tool to generate the meta-datum adapted to indicate an answer corresponding to the human marking occurring in the marking region.

7. The system according to claim 6, wherein the meta-datum is further adapted to indicate a mark type.

8. The system according to claim 7, wherein the mark type is one of Indicates-Error indication type, Indicates-Correct indication type, Selects-Result indication type, Is-Result indication type, Survey-Selection indication type, and Connector indication type.

9. The system according to claim 1, wherein the user interface is further adapted for user preview of the printed assessment including user preview of the marking region, wherein the marking region is selected via received user input from the user interface.

10. The system according to claim 1, wherein the printed assessment is adapted for being image processed.

11. The system according to claim 1, further comprising a marketplace interface component adapted to communicate the assessment data structure with an electronic marketplace.

12. A system for printing assessments on a multifunction device, comprising:
a user interface adapted to communicate user input; and
an assessment generation component in operative communication with the user interface and configured to receive the user input therefrom, the assessment generation component adapted to generate an assessment data structure as at least a function of the user input, the assessment data structure, comprising:
printing data configured to operatively instruct the multifunction device to print an assessment having at least one marking region adapted to receive at least one human marking; and
meta-data including a meta-datum adapted to indicate an answer corresponding to a human marking of the at least one human marking occurring in a marking region of the at least one marking region.

13. The system according to claim 12, wherein the meta-datum adapted to indicate the answer is further adapted to indicate one of a correct answer and an incorrect answer as corresponding to the human marking of the at least one human marking occurring in the marking region of the at least one marking region.

14. The system according to claim 12, wherein the assessment generation component generates the assessment data structure by modifying another assessment data structure.

15. The system according to claim 12, wherein the assessment generation component generates the assessment data structure such that the printing data includes a scanned image.

16. The system according to claim 12, wherein the assessment generation component operatively utilizes an assessment data structure template to generate the assessment data structure.

17. The system according to claim 12, wherein the meta-data includes at least one global meta-datum.

18. The system according to claim 17, wherein the at least one global meta-datum includes at least one of a bar code field, a bar code print location, a variable print data pointer, a variable print data print location, a document name, a print characteristic, a registration mark, and a registration mark print location.

19. The system according to claim 17, wherein the at least one global meta-datum is adapted to instruct the multifunction device to print a print object within a print region of the printed assessment.

20. The system according to claim 12, wherein the printing data is includes at least one of a page description language data structure, a portable document format data structure, a postscript data structure, a raw image, a compressed image, and a print job.

21. The system according to claim 12, wherein the user interface is further adapted for user preview of the printed assessment including user preview of the at least one marking region, wherein the user interface is further adapted for user selection of a second marking region of the at least one marking region utilizing the user preview of the at least one marking region, wherein the system further comprises:
a meta-datum configuration component in operative communication with the user interface and adapted to receive user input therefrom, wherein the meta-datum configuration component is adapted to configure a second meta-datum of the meta-data of the assessment data structure such that the second meta-datum is adapted for association with a second human marking of the at least one human markings within the selected second marking region of the at least one marking region.

22. The system according to claim 12, wherein the printing data of the assessment data structure includes a question datum adapted to operatively instruct the multifunction device to print the a question on the printed assessment, wherein the question is associated with the human marking of the at least one human marking within the marking region of the at least one marking region.

23. The system according to claim 22, wherein the meta-datum is adapted to indicate the answer as corresponding to the human marking such that the human marking is in response to the printed question.

24. The system according to claim 12, wherein the meta-data including a meta-datum adapted to indicate an answer corresponding to a human marking of the at least one human marking occurring in a marking region of the at least one marking region has a plurality of states including a first state adapted to indicate a correct answer and a second state adapted to indicate an incorrect answer.
